(19) United States
(12) Patent Application Publication
(10) Pub. No.: US 2013/0012383 A1
(43) Pub. Date: Jan. 10, 2013

(54) USE OF AMINOCARBOXYLATES IN AGRICULTURE

(75) Inventors: Stephan Hüffer, Ludwigshafen (DE); Frank-Peter Lang, Hattersheim (DE); Alejandra Garcia Marcos, Ludwigshafen (DE); Alexander Wissemeier, Speyer (DE); Wolfgang Staffel, Otterstadt (DE)

(73) Assignee: BASF SE, Ludwigshafen (DE)

(21) Appl. No.: 13/533,083

(22) Filed: Jun. 26, 2012

Related U.S. Application Data
(60) Provisional application No. 61/563,627, filed on Nov. 25, 2011.
(60) Provisional application No. 61/502,345, filed on Jun. 29, 2011.

(30) Foreign Application Priority Data
Jun. 29, 2011 (EP) 11171904.3
May 29, 2012 (EP) 12169830.2

(51) Int. Cl. C05G 3/02; C05B 15/00; C05F 11/00

(52) U.S. Cl. 504/101; 504/358; 71/27

(57) ABSTRACT

Use of formulations comprising
(A) one or more aminocarboxylates, selected from among methylglycine diacetate (MGDA) and its alkali metal salts and glutamic diacetate (GLDA) and its alkali metal salts,
(B) at least one inorganic compound selected from among inorganic phosphates, inorganic phosphites, inorganic nitrates, ammonium salts and potassium salts and
(C) optionally water for the application to plants, the ground or growth substrates.

The present invention relates to the use of formulations comprising
(A) one or more aminocarboxylates, selected from among methylglycine diacetate (MGDA) and its alkali metal salts and glutamic diacetate (GLDA) and its alkali metal salts,
(B) at least one inorganic compound selected from among inorganic phosphates, inorganic phosphites, inorganic nitrates, ammonium salts and potassium salts and
(C) optionally water
   for the application to plants, the ground or growth substrates.

The present invention furthermore relates to formulations comprising
(A) one or more aminocarboxylates, selected from among methylglycine diacetate (MGDA) and its alkali metal salts and glutamic diacetate (GLDA) and its alkali metal salts,
(B) at least one inorganic compound selected from among inorganic phosphates, inorganic phosphites, inorganic nitrates, ammonium salts and potassium salts and
(C) optionally water.

The present invention furthermore relates to a process for the preparation of formulations according to the invention. The present invention furthermore relates to the use of aqueous formulations comprising
(A) one or more aminocarboxylates, selected from among methylglycine diacetate (MGDA) and its alkali metal salts and glutamic diacetate (GLDA) and its alkali metal salts, to be applied to plants or the ground or growth substrates.

It has long been attempted to improve the yields of soils in terms of fertility. By using fertilizers, in particular what are known as NPK fertilizers, it is indeed possible to improve the essential mineral content. However, it is observed that, in many cases, only fractions of the minerals supplied to the soil are indeed taken up into plants. A considerable fraction of the minerals supplied, in contrast, is not taken up but enters the groundwater, where in particular nitrates and phosphates are undesired. Excess fertilizer application, therefore, is not acceptable.

Regular fertilizing with low fertilizer concentrations is too time-consuming.

The bioavailability of phosphates is a problem. Phosphate minerals which, in many cases, include phosphate in a sparingly water-soluble form will in many cases not be effective as phosphate fertilizer in nature. The use of what are known as soluble phosphates, which has already been proposed as a solution, will, in soils which comprise significant amounts of calcium or iron ions in dissolved form, result in the precipitation of sparingly-soluble phosphates, so that the problem of the bioavailability of phosphate cannot be considered as solved. What is known as the mineralization of soluble phosphates can take place within a period of less than two weeks, depending on the soil composition.

An object was therefore to provide formulations whose mineral fertilizer component can be taken up readily by soils or plants. A further object was to provide uses of formulations by means of which mineral fertilizers, and in particular phosphate, can be taken up readily by soils or plants. A further object was to provide a method by means of which phosphate can be rendered readily bioavailable.

Accordingly, there have been found the uses and formulations defined at the outset.

According to the invention, there is used at least one formulation comprising
(A) one or more aminocarboxylates, selected from among methylglycine diacetate (MGDA) and its alkali metal salts and glutamic diacetate (GLDA) and its alkali metal salts, in each case also called aminocarboxylate (A) or else, summarily, compound (A) for short,
(B) at least one inorganic compound, also called inorganic compound (B) for short, selected from among inorganic phosphates, inorganic phosphites, inorganic nitrates, ammonium salts and potassium salts and
(C) optionally water
   for the application to plants or the ground or growth substrate.

Compound (A) can be present as the free acid or, preferably, in partially or fully neutralized form, in other words as a salt. Examples of suitable counterions are inorganic cations, for example ammonium, alkali metal or alkaline-earth metal, preferably Mg²⁺, Ca²⁺, Na⁺, K⁺, or organic cations, preferably ammonium which is substituted by one or more organic radicals, in particular triethanolammonium, N,N-diethanolammonium, N-mono-C₁-C₄-alkyldiethanolammonium, for example N-methyldiethanolammonium or N-n-butyldiethanolammonium, and N,N-di-C₁-C₄-alkylethanolammonium. Preferred ions are alkali-metal ions, especially preferably Na⁺ and K⁺.

In one embodiment of the present invention, compound (A) is selected from among derivatives of aminocarboxylates (A), for example from their methyl or ethyl esters.

Compound (A) is selected from among methylglycine diacetate (MGDA) and glutamic diacetate (GLDA) and their derivatives and preferably their salts, in particular their sodium and potassium salts. Very especially preferred are methylglycine diacetate and the trisodium salt of MGDA.

In one embodiment of the present invention, the formulations used are those which include at least one aminocarboxylate (A), selected from among methylglycine diacetate (MGDA) and its alkali metal salts and glutamic diacetate (GLDA) and its alkali metal salts and furthermore at least one polyaminocarboxylate (A).

For the purposes of the present invention, polyaminocarboxylates (A) are understood as meaning those organic compounds which include at least two tertiary amino groups which, independently from one another, include in each case one or two CH₂-COOH groups which can be partially or fully neutralized, as mentioned above.

In another embodiment of the present invention, polyaminocarboxylates (A) are selected from among those organic compounds which include at least two secondary amino groups, each of which includes one CH(COOH)CH₂-COOH groups which can be partially or fully neutralized, as mentioned above.

Preferred polyaminocarboxylates (A) are selected from among 1,2-diaminoethanetetraacetic acid (EDTA), ethylenediaminedisuccinate (EDDS), diethylenetriaminepentaacetate (DTPA), hydroxyethylenediaminetriacetate (HEDTA) and their respective salts, in particular alkali metal salts, very especially preferred are the sodium salts and potassium salts, and mixed sodium potassium salts.

Inorganic compound (B) is selected from among inorganic phosphates, inorganic phosphites, inorganic nitrates, ammonium salts and potassium salts, it being possible for inorganic compound (B) to fall within one or more of the abovementioned categories.

Examples of inorganic nitrates are sodium nitrate, ammonium nitrate and potassium nitrate, potassium nitrate being an example of an inorganic compound (B) which falls both within the term potassium salts and within inorganic nitrates.

Potassium salts and ammonium salts may have inorganic or organic counterions, inorganic counterions being preferred.

Examples of potassium salts which may be selected as inorganic compound (B) are potassium chloride, potassium sulfate, potassium nitrate, potassium citrate, potassium dihydrogenphosphate, dipotassium hydrogenphosphate, potassium metaphosphate, potassium orthophosphate and potassium salts of MGDA or GLDA, with potassium nitrate, potassium dihydrogenphosphate, dipotassium hydrogenphosphate, potassium metaphosphate, potassium orthophosphate and potassium salts of MGDA or GLDA being examples of compounds which fall within a plurality of terms within the scope of the present invention.

Examples of ammonium salts are ammonium sulfate, ammonium nitrate, ammonium citrate, ammonium chloride, ammonium dihydrogenphosphate, diammonium hydrogenphosphate, ammonium metaphosphate, ammonium orthophosphate and ammonium salts of MGDA or of GLDA, with ammonium nitrate, ammonium dihydrogenphosphate, diammonium hydrogenphosphate, ammonium metaphosphate, ammonium orthophosphate and ammonium salts of MGDA and of GLDA being examples of compounds which fall within a plurality of terms within the scope of the present invention.

Examples of inorganic phosphates are inorganic and organic salts of metaphosphoric acid, orthophosphoric acid, diphosphoric acid or higher polyphosphoric acids including triphosphoric acid. The term “salts of orthophosphoric acid” includes the corresponding mono- and dihydrogenphosphates.

Other examples of inorganic phosphates are natural phosphate-comprising minerals, so-called natural phosphates or crude phosphates, for example apatites such as hydroxyapatite.

In one embodiment of the present invention, inorganic compound (B) is selected from among sodium dihydrogenphosphate, disodium hydrogenphosphate, ammonium dihydrogenphosphate, diammonium hydrogenphosphate, potassium dihydrogenphosphate, dipotassium hydrogenphosphate, potassium nitrate, sodium nitrate, ammonium sulfate, superphosphate and alkali metal and alkaline-earth metal salts of tripolyphosphate, and natural phosphate-comprising minerals.

As a rule, natural phosphates comprise a certain amount of impurities. In this context, impurities are considered to be compounds of those elements which are not part of the general formula under which the natural phosphate in question usually comes. Thus, hydroxyapatite has, as a rule, the formula Ca₅(PO₄)3(OH) assigned to it. In addition, it is possible for example for MgO, Al₂O₃, Fe₂O₃, F⁻, CO₃²⁻, SO₄²⁻, SiO₂ (or silicate) or Cl⁻ contents to be present.

As a rule, natural phosphates are sparingly soluble in water. If it is desired to use them in accordance with the invention, for example in formulation according to the invention, it is preferred to employ them in comminuted form, for example with a mean particle diameter in the range of from 0.5 to 500 μm, preferably 2 to 100 μm. Comminuting can be effected for example by grinding.

In accordance with the invention, one uses formulations which may comprise water (C). Formulations according to the invention may comprise water (C). Water may be present for example in amounts of from 0.1 to 10% by weight, based on the total formulation according to the invention, or the total formulation used in accordance with the invention. In another embodiment, formulation according to the invention, or formulation used in accordance with the invention, comprises more than 10 up to 95% by weight, of water. In another embodiment of the present invention, formulation according to the invention, or formulation used in accordance with the invention, comprises water (C) in the range of from 95.01 to 99.9% by weight.

Formulations according to the invention may be present as a powder, a moist powder, a suspension, a powder slurry or a solution.

To employ formulations according to the invention, they can be applied to plants or to ground or to growth substrate, for example as a fertilizer. To this end, formulation according to the invention can be applied manually or mechanically to bare soil or growth substrate or to soil or growth substrate which is not vegetated, or else formulation according to the invention may be applied manually or mechanically to plants.

For the purposes of the present invention, growth substrate is understood as meaning soil-comprising substrates and industrial soils which are employed for example in hydroponic cultures or greenhouses.

Examples of suitable plants are vegetables, cereals, trees, root crops, bushes, shrubs and flowers. Especially preferred are oilseed rape, wheat, millet/sorghum, rye, barley, avocado, citrus fruits, mango, coffee, deciduous tree crops, grapes and other soft fruit plants, beans, in particular soybeans, furthermore maize, tomatoes, cucumbers, in particular zucchini and salad cucumbers, pumpkins, furthermore stone fruit, lettuce, potatoes, field beet, sugar beet, paprika, sugarcane, hops, tobacco, pineapple, palms, in particular coconut palms, furthermore rubber trees, including Brazilian rubber trees (Hevea brasiliensis), and ornamental plants, in particular roses, dahlias, hydrangeas, tulips, narcissus, daffodils, carnations and chrysanthemums.

For application purposes, formulation according to the invention can be applied above an area to be treated, for example by aircraft or vehicle, or it can be applied with the aid of an irrigation system. Types of application are spraying and root dosage, liquid or solid.

In one embodiment of the present invention, at least one formulation comprising at least one cation selected from among Ca²⁺, Mg²⁺, Cu²⁺, Mn²⁺, Zn²⁺, Fe²⁺, Fe³⁺, Al³⁺, Cr³⁺ and Co²⁺ in chelated form is used. In this context, the cation in question is preferably chelated by compound (A).

In one embodiment of the present invention, the formulation used according to the invention comprises chelated cation(s) selected from among Ca²⁺, Mg²⁺, Cu²⁺, Mn²⁺, Zn²⁺, Fe²⁺, Fe³⁺, Al³⁺, Cr³⁺ and Co²⁺ in the range of in total 0.001 to 10% by weight, preferably 0.01 to 5% by weight, based on the total amount of compound(s) (A).

In one embodiment of the present invention, the formulation used according to the invention may comprise further trace elements, for example boron (as borate) or molybdenum.

In one embodiment of the present invention, the formulation used according to the invention may comprise in the range of in total 0.001 to 10% by weight, preferably 0.01 to 5% by weight, based on the total amount of compound(s) (A), further trace elements, for example boron (as borate) or molybdenum in the range of in total 0.001 to 10% by weight, preferably 0.01 to 5% by weight, based on the total amount of compound(s) (A).

In one embodiment of the present invention, at least one formulation is used in accordance with the invention, which formulation comprises at least one organic compound (D) selected from among urea and citric acid and its alkali metal salts. Preferred alkali metal salts of citric acid are tripotassium citrate (“potassium citrate”) and the trisodium salt of citric acid (“sodium citrate”).

In one embodiment of the present invention, at least one formulation is used in accordance with the invention, which formulation comprises at least one active substance (E) selected from among fungicides, herbicides and insecticides.

In one embodiment of the present invention, at least one formulation is used in accordance with the invention, which formulation comprises at least one additive (F) selected from among wetters, antifoams, surfactants and spreaders (spreading agents). Particularly suitable additives (F) are inorganic surfactants, for example C₈-C₂₀-alkylsulfates, C₈-C₂₀-alkylsulfonates and C₈-C₂₀-alkyl ether sulfates having one to 6 ethylene oxide units per molecule. In this context, it is possible for example that the same surfactant acts as wetter and as antifoam or as wetter and antifoam.

In one embodiment of the present invention, at least one formulation is used according to the invention which comprises at least one further inorganic compound, for example sodium hydroxide or an inorganic sulfate.

A further subject matter of the present invention are formulations comprising
(A) one or more aminocarboxylates, selected from among methylglycine diacetate (MGDA) and its alkali metal salts and glutamic diacetate (GLDA) and its alkali metal salts,
(B) at least one inorganic compound (B), and
(C) optionally water.

In one embodiment of the present invention, formulation according to the invention comprises at least one aminocarboxylate (A) and at least one polyaminocarboxylate (A).

Aminocarboxylates (A), polyaminocarboxylates (A) and compounds (B) are described hereinabove.

In one embodiment of the present invention, inorganic compound (B) is selected from among sodium dihydrogenphosphate, disodium hydrogenphosphate, ammonium dihydrogenphosphate, diammonium hydrogenphosphate, potassium dihydrogenphosphate, dipotassium hydrogenphosphate, potassium nitrate, sodium nitrate, ammonium sulfate, superphosphate and alkali metal and alkaline-earth metal salts of tripolyphosphate, and natural phosphate-comprising minerals.

In one embodiment of the present invention, formulation according to the invention comprises: in total in the range of from 1 to 90% by weight, preferably 10 to 50% by weight, of aminocarboxylate (A), selected from among methylglycine diacetate (MGDA) and its alkali metal salts and glutamic diacetate (GLDA) and its alkali metal salts, and optionally polyaminocarboxylate (A), where the context of polyaminocarboxylate (A) may be zero, and in total in the range of from 10 to 99% by weight, preferably 50 to 90% by weight, of inorganic compound (B).

In this context, % by weight refers in each case to the solids content of formulation according to the invention.

Formulation according to the invention may furthermore comprise water (C).

In one embodiment of the present invention, the formulation according to the invention comprises at least one cation selected from among Ca²⁺, Mg²⁺, Cu²⁺, Mn²⁺, Zn²⁺, Fe²⁺, Fe³⁺, Al³⁺, Cr³⁺ and Co²⁺ in chelated form. In this context, the cation in question is preferably chelated by compound (A).

In one embodiment of the present invention, the formulation according to the invention comprises chelated cation(s) selected from among Ca²⁺, Mg²⁺, Cu²⁺, Mn²⁺, Zn²⁺, Fe²⁺, Fe³⁺, Al³⁺, Cr³⁺ and Co²⁺ in the range of in total 0.001 to 10% by weight, preferably 0.01 to 5% by weight, based on the total amount of compound(s) (A).

In one embodiment of the present invention, the formulation according to the invention comprises in total in the range of from 0.01 to 2% by weight. preferably from 0.02 to 1% by weight, of cation(s) selected from among Ca²⁺, Mg²⁺, Cu²⁺, Mn²⁺, Zn²⁺, Fe²⁺, Fe³⁺, Al³⁺, Cr³⁺ and Co²⁺ in chelated form, the percentage by weight being based on the total amount of inorganic compound (B).

In one embodiment of the present invention, the formulation according to the invention may comprise further trace elements, for example boron (as borate) or molybdenum.

In one embodiment of the present invention the formulation according to the invention may comprise further trace elements in the range of in total 0.001 to 10% by weight, preferably 0.01 to 5% by weight, based on the total amount of compound(s) (A), for example boron (as borate) or molybdenum in the range of in total 0.001 to 10% by weight, preferably 0.01 to 5% by weight, based on the total amount of compound(s) (A).

In one embodiment of the present invention, formulation according to the invention comprises at least one further substance selected from among
(D) organic compounds which are selected from among urea and citric acid and its alkali metal salts,
(E) active substances selected from among herbicides, fungicides and insecticides,
(F) additives selected from among wetters, antifoams, surfactants and spreaders.

Organic compounds (D), active substances (E) and additives (F) are described hereinabove.

In one embodiment of the present invention, formulation according to the invention comprises

in total in the range of from zero to 15% by weight, preferably 1 to 10% by weight, of organic compound(s) (D),

in total in the range of from zero to 5% by weight, preferably 0.1 to 2.5% by weight, of active substance(s) (E),

in total in the range of from zero to 5% by weight, preferably 0.1 to 2% by weight, of additive(s) (F).

In this context, % by weight refers in each case to the solids content of formulation according to the invention.

In one embodiment of the present invention, the formulation according to the invention has a pH in the range from 5 to 9, preferably from 6 to 8.

In one embodiment of the present invention, the formulation according to the invention may comprise at least one further inorganic compound, for example sodium hydroxide or an inorganic sulfate.

Formulations according to the invention can be used in a particularly suitable manner for efficiently improving the mineral supply of plants without large amounts of undesired salts reaching the groundwater or leading to the eutrophication of inland river courses.

In embodiments in which the formulation according to the invention comprises chelated cation(s) selected from among Ca²⁺, Mg²⁺, Cu²⁺, Mn²⁺, Zn²⁺, Fe²⁺, Fe³⁺, Al³⁺, Cr³⁺ and Co²⁺, the formulation according to the invention may furthermore be used as a micronutrient fertilizer.

A further subject matter of the present invention is a process for the preparation of formulations according to the invention, also referred to in the context of the present invention as preparation process according to the invention.

In one embodiment of the preparation process according to the invention, a procedure is followed in which
(A) one or more aminocarboxylate(s) (A), selected from among methylglycine diacetate (MGDA) and its alkali metal salts and glutamic diacetate (GLDA) and its alkali metal salts,
(B) at least one inorganic compound selected from among inorganic phosphates, inorganic phosphites, ammonium salts and potassium salts
   are mixed with each other in the presence of water (C) and
   all or some of the water (C) is optionally removed.

In one embodiment of the present invention, at least one compound (A) and at least one inorganic compound (B) are dissolved in water (C), for example in 10% by volume up to the 10-fold (volume-based), based on the total of compound (A) and inorganic compound (B). Thereafter, all or some of the water (C) may be removed.

In another embodiment of the present invention, at least one inorganic compound (B) is suspended in a solution of at least one compound (A) in water (C), for example in 10% by volume up to the 10-fold (volume-based), based on the total of compound (A) and inorganic compound (B). Thereafter, all or some of the water (C) may be removed. This embodiment is preferred when inorganic compound (B) takes the form of a natural phosphate.

In another embodiment of the present invention, at least one inorganic compound (B) is ground in a solution of at least one compound (A) in water (C), for example in 10% by volume up to the 10-fold (volume-based), based on the total of compound (A) and inorganic compound (B). Thereafter, all or some of the water (C) may be removed. This embodiment is preferred when inorganic compound (B) takes the form of a natural phosphate.

In another embodiment of the preparation process according to the invention, a procedure is followed in which, in the presence of water (C) and
(A) one or more aminocarboxylate(s), selected from among methylglycine diacetate (MGDA) and its alkali metal salts and glutamic diacetate (GLDA) and its alkali metal salts,
(B) at least one inorganic compound, preferably at least two inorganic compounds, in each case selected from among inorganic phosphates, inorganic phosphites, ammonium salts and potassium salts
   is prepared and
   all or some of the water (C) is optionally removed.

Thus, it is possible, for example, to select potassium hydroxide and phosphoric acid as inorganic compounds (B) and thereby to prepare potassium phosphate, potassium dihydrogenphosphate and/or dipotassium hydrogenphosphate in situ.

In another variant, potassium hydroxide is employed as the inorganic compound (B), and a mixture with aminocarboxylate(s) (A) or polyaminocarboxylate(s) as free acid(s) is prepared in the presence of water (C), in which manner potassium salts of aminocarboxylate(s) (A) or polyaminocarboxylate(s), respectively, are prepared.

In one embodiment of the present invention, in particular if it is desired to prepare formulations according to the invention to be employed for the micronutrient fertilization, at least one compound which includes at least one cation selected from among Ca²⁺, Mg²⁺, Cu²⁺, Mn²⁺, Zn²⁺, Fe²⁺, Fe³⁺, Al³⁺, Cr³⁺ and Co²⁺ is additionally also employed. Examples of suitable compounds are sulfates, nitrates, phosphates, halides, in particular chlorides, and especially preferably nitrates and sulfates. Suitable compounds may comprise water of hydration or else be anhydrous. In one variant, complex compounds are employed, for example aquo complexes or amino complexes of Cu²⁺, Mn²⁺, Zn²⁺, Fe²⁺, Fe³⁺, Al³⁺, Cr³⁺ and Co²⁺. In one variant, a plurality of compounds, each of which includes at least one cation selected from among Ca²⁺, Mg²⁺, Cu²⁺, Mn²⁺, Zn²⁺, Fe²⁺, Fe³⁺, Al³⁺, Cr³⁺ and Co²⁺, are employed.

In one embodiment of the present invention, further compounds may be added, for example boric acid, sodium borate, molybdenum oxide, ammonium molybdate, heteropolyacids of molybdenum or their salts, for example molybdatophosphoric acid or the sodium or ammonium salt of molybdatophosphoric acid.

In one variant, at least one inorganic compound (B) is added which is contaminated with traces of at least one compound which includes at least one cation selected from among Ca²⁺, Mg²⁺, Cu²⁺, Mn²⁺, Zn²⁺, Fe²⁺, Fe³⁺, Al³⁺, Cr³⁺ and Co²⁺.

Optionally, it is possible in each case before or after removal of the water (C), additionally to prepare a mixture with at least one further substance selected from among
(D) organic compounds which are selected from among urea and citric acid and its alkali metal salts,
(E) active substances selected from among herbicides, fungicides and insecticides and
(F) additives selected from among wetters, antifoams, surfactants and spreaders.

In another embodiment, it is possible additionally to prepare a mixture with at least one further substance selected from among
(D) organic compounds which are selected from among urea and citric acid and its alkali metal salts,
(E) active substances selected from among herbicides, fungicides and insecticides and
(F) additives selected from among wetters, antifoams, surfactants and spreaders without removing the water (C).

In one embodiment of the preparation process according to the invention, a procedure is followed in which all or some of the water (C) is removed by evaporation, distillation, lyophilization, in particular by spray-drying or spray-granulating.

A further subject matter of the present invention is a method of fertilizing plants, wherein at least one formulation according to the invention is applied mechanically or manually to the ground and/or to plants.

A further subject matter of the present invention is the use of aqueous formulations comprising
(A) one or more aminocarboxylates, selected from among methylglycine diacetate (MGDA) and its alkali metal salts and glutamic diacetate (GLDA) and its alkali metal salts, for the application to plants or to the ground.

A further subject matter of the present invention is the use of aqueous formulations comprising
(A) one or more aminocarboxylates, selected from among methylglycine diacetate (MGDA) and its alkali metal salts and glutamic diacetate (GLDA) and its alkali metal salts, for the application to growth substrates for plants.

Aqueous formulations for the two last-mentioned uses may comprise at least one further substance selected from among
(D) organic compounds which are selected from among urea and citric acid and its alkali metal salts,
(E) active substances selected from among herbicides, fungicides and insecticides and
(F) additives selected from among wetters, antifoams, surfactants and spreaders.

However, they are free from inorganic compound (B).

Especially preferred compounds (A) in the two last-mentioned uses are the sodium salts and in particular the potassium salts of GLDA and MGDA.

In one variant, one or more compounds which include in each case at least one cation selected from among Ca²⁺, Mg²⁺, Cu²⁺, Mn²⁺, Zn²⁺, Fe²⁺, Fe³⁺, Al³⁺, Cr³⁺ and Co²⁺ are additionally employed in such uses according to the invention.

In one embodiment of the present invention, further compounds may be added, for example boric acid, sodium borate, molybdenum oxide, ammonium molybdate, heteropolyacids of molybdenum or their salts, for example molybdatophosphoric acid or the sodium or ammonium salt of molybdatophosphoric acid.

The invention is illustrated by working examples.

Unless expressly specified otherwise, all % are % by weight.

I. Preparation of Formulations According to the Invention and of Comparative Formulations:

I.1 Preparation of Formulation F.1

300 g of the tripotassium salt of methylglycinediacetate (A.1) were dissolved in 600 g of water. A pH of 7 was adjusted with semiconcentrated sulfuric acid, and the mixture was diluted with water to a total weight of 1000 g.

This gave formulation F.1 as a stable solution which, due to the K₂O content of 12.5%, comprised a fertilizer with the classification 0-0-12.5.

I.2 Preparation of Formulation F.2

260 g of the trisodium salt of methylglycinediacetate (A.2) were dissolved in 600 g of water. A pH of 7 was adjusted with semiconcentrated sulfuric acid, and the mixture was diluted with water to a total weight of 1000 g.

This gave formulation F.2 as a stable solution.

I.3 Preparation of Formulation EF.3 According to the Invention

240 g of the tripotassium salt of methylglycinediacetate (A.1) and 150 g of diammonium orthophosphate (B.2) were dissolved in 560 g of water. A pH of 7.5 was adjusted using 60 g of phosphoric acid (B.3). This gave formulation EF.3 according to the invention as a stable solution, which comprised a fertilizer with the classification 2.7-10.7-8.1.

I.4 Preparation of Formulation EF.4 According to the Invention

250 g of the tripotassium salt of methylglycinediacetate (A.1) together with 250 g of Moroccan crude phosphate 0-30-0 (particle size 20-100 μm) (B.4) were made into a slurry with 300 g of water and stirred for six hours at 80° C. Thereafter, 60 g of concentrated phosphoric acid (B.3) were added and the suspension was stirred at 40° C. over a period of 5 minutes. Thereafter, the mixture was diluted with water to a total weight of 1000 g. The formulation had a pH of 7.5. This gave formulation EF.4 according to the invention as a suspension with the classification 0-11-10.8.

The Moroccan crude phosphate employed had the following composition, as determined by elemental analysis:

| | |
|---|---|
| P₂O₅ | 30% |
| CaO | 48.0 to 49.5% |
| MgO | 0.3 to 0.4% |
| Al₂O₃ | 0.3 to 0.5% |
| Fe₂O₃ | 1.9 to 2.2% |
| K₂O | 0.04-0.06% |
| SiO₂ | 5.0 to 6.5% |
| F | 3.0 to 3.1% |
| Na₂O | 0.4 to 0.6% |
| CaCO₃ | 10.2 to 11.8% |
| (CO₂ | 4.5 to 5.2%) |
| SO₄²⁻ | 1.5 to 2.0, |
| | determined as SO₃ |
| H₂O | 4% MAX |
| Cl | 0.05 to 0.09% |

I.5 Preparation of Comparative Formulation V-F.5

300 g of diammonium monohydrogenphosphate (B.2) and 90 g of potassium hydroxide were dissolved in 510 ml of water, and 100 g of concentrated phosphoric acid (B.3) were added, with cooling. This gave a fertilizer formulation (pH 7-8) of the composition 5.4-20.1-6.3.

Pure water was employed as comparative formulation V-F.6.

II. Uses According to the Invention and Comparative Uses of Formulations

For testing, the formulations according to the invention and the formulations not according to the invention were in each case diluted with water in the ratio 1/200, this gave fertilizer solutions according to the invention and fertilizer solutions not according to the invention.

II.1 Treatment of Tomatoes

The primary fertilization of the soil was carried out using in each case 10 ml of fertilizer solution per pot. To fertilize the tomato plants after 35 days (see hereinbelow), in each case 5 ml of the same fertilizer solution were sprayed onto the tomato plant.

Plastics pots 5 inches in diameter were filled with medium-heavy loose-sediment brown earth from the Bavarian foothills of the Alps. The loose-sediment brown earth employed had a phosphate content (determined as P₂O₅) of 22 mg P₂O₅/100 g soil.

To test a fertilizer solution, in each case 10 pots were planted; the data listed in tables 1 and 2 are in each case means of in each case 5 pots/fertilizer solution.

Tomato seeds “Berner Rose” (Solanum lycopersicum) were planted at a depth of 2.5 cm at a rate of 3 seeds per pot. The primary fertilization with in each case 10 ml of fertilizer solution (see above) was applied at a depth of 2 cm, immediately after planting. The tomato plants were first grown for 35 days in the greenhouse under standard conditions until the beginning of anthesis.

Analysis after 35 days:

The tomato plants of in each case 5 of the 10 pots in question were cut off above the roots, washed with water and dried at 75° C. over a period of 24 hours. Thereafter, they were analyzed for potassium and phosphate. The result is compiled in table 1.

TABLE 1
Analysis of the tomato plants after 35 days

| | K₂O [% by wt.] | P₂O₅ [% by wt.] |
|---|---|---|
| F.1 | 1.73 | 0.53 |
| F.2 | 1.26 | 0.50 |
| EF.3 | 1.56 | 0.71 |
| EF.4 | 1.64 | 0.61 |
| V-F.5 | 1.53 | 0.55 |
| V-F.6 | 1.30 | 0.34 |

The tomato plants of the remaining in each case 5 of the in each case 10 pots were sprayed with in each case 5 ml of the diluted fertilizer formulations and grown for a further 45 days in the greenhouse under standard conditions. After 70 days, the plants were cut off, the still unripe fruits were removed, and the plants were analyzed as described above. The results are compiled accordingly in table 2.

TABLE 2
Analysis of the tomato plants after 70 days

| | K₂O [%] | P₂O₅ [%] |
|---|---|---|
| F.1 | 1.69 | 0.48 |
| F.2 | 1.26 | 0.51 |
| EF.3 | 1.56 | 0.66 |
| EF.4 | 1.64 | 0.61 |
| V-F.5 | 1.53 | 0.51 |
| V-F.6 | 1.21 | 0.29 |

II.2 Treatment of Potatoes

A waxy table potato cv. Annabelle was planted on 1.5 hectares. Planting was as recommended by the Amt für Landwirtschaft and Forsten [Department of Agriculture and Forestry] Augsburg, ALF A-2.1P-Stadtbergen, 18.02.2009 (Hinweise zum Kartoffelanbau [Notes on potato planting] 2009). The planting distance was in each case 33 cm and the rows were spaced 75 cm apart, corresponding to a plant number of 41 000 plants per ha.

The soil of the field had a phosphate content (determined as P₂O₅) of 21 mg/100 g soil.

Plants were grown traditionally on field plot 1 using comparative formulation V-F.5. Food plot 2 was treated with formulation EF.3 according to the invention. Food plot 3 was treated with formulation EF.1 according to the invention, in other words without the addition of phosphate. V-F.6 was employed in field plot 4.

The fertilization was carried out in the form of a two-step basal dressing by applying in each case in accordance with the invention and by comparison 250 kg/ha in the spring, and a further 200 kg/ha at the beginning of tuber formation (buffing up). 60 days after planting, a top dressing of in each case 250 kg/ha was applied by foliar application. Fertilization with magnesium in the form of kieserite (27% MgO) was always carried out with 45 kg of MgO/ha (basal dressing). By replenishing potassium salt, a calculated total amount of K₂O of (converted) 140 kg K₂O /ha was applied in total. Nitrogen fertilization is carried out with an amount of (in total) 160 kg/ha.

In addition, the plots were managed identically (planting density, chitting, pest control, disease prevention and the like, see ALF A-2.1 P-).

After 160 days, the plants were harvested. The results are compiled in table 3.

Phosphorus was determined using dried, powdered potatoes, the P content being back converted to the weight of the freshly harvested potatoes. To this end, 25 kg of potatoes (randomly chosen) were first shredded, dried and then powdered. The P content was determined by elemental analysis.

TABLE 3
Results of P content of potatoes and yield

| | | Yield in | P content potatoes |
|---|---|---|---|
| | Formulation | tonnes/ha | [mg/kg] |
| Field plot 1 | V-F.5 | 41 | 500 |
| Field plot 2 | EF.3 | 45 | 512 |
| Field plot 3 | F.1 | 39 | 494 |
| Field plot 4 | V-F.6 | 32 | 461 |

Therefore, good results were obtained on field plot 3 although no separate P fertilization was carried out.

III. Use as Micronutrient Fertilizer

The following formulations are prepared for use as micronutrient fertilizer:

III.1 Preparation of a Formulation According to the Invention EF.7

300 g of the tripotassium salt of methylglycine diacetate (A.1) are dissolved in 600 g of water.

The following are also added:

171 mg of boric acid (corresponds to 0.01% by weight of boron),

47 mg of CuSO₄·5H₂O (corresponds to 0.004% by weight of copper),

111 mg of MnSO₄·H₂O (corresponds to 0.012% by weight of manganese),

55 mg of Zn(NO₃)₂·6H₂O (corresponds to 0.004% by weight of zinc),

73 mg of molybdatophosphoric acid (12 MoO₃·H₃PO₄·x H₂O, water content 22% by weight, corresponds to 0.001% by weight of molybdenum.

The mixture is brought to pH 7 using semi-concentrated sulfuric acid and diluted with water to a total weight of 1000 g.

This gives the formulation according to the invention EF.7. It is suitable for use for example as a hydrangea fertilizer.

III.2 Preparation of a Formulation According to the Invention EF.8

240 g of the tripotassium salt of methylglycine diacetate (A.1) and 150 g of diammonium orthophosphate (B.2) are dissolved in 560 g of water.

265 mg of boric acid (corresponds to 0.01% by weight of boron),

122 mg of CuSO₄·5H₂O (corresponds to 0.007% by weight of copper),

142 mg of MnSO₄·H₂O (corresponds to 0.013% by weight of manganese),

119 mg of Zn(NO₃)₂·6H₂O (corresponds to 0.006% by weight of zinc),

3.0 g of FeSO₄·7H₂O (corresponds to 0.2% by weight of iron)

109 mg of molybdatophosphoric acid (12 MoO₃·H₃PO₄·x H₂O, water content 22% by weight, corresponds to 0.001% by weight of molybdenum)

60 g of phosphoric acid (B.3) are added. This gives the formulation according to the invention EF.8. It is suitable for use for example as a rose fertilizer.

III.3 Preparation of a formulation according to the invention EF.9

240 g of the tripotassium salt of methylglycine diacetate (A.1), 75 g of ammonium sulfate and

75 g of potassium nitrate (B.2) are dissolved in 560 g of water.

265 mg of boric acid (corresponds to 0.01% by weight of boron),

70 mg of CuSO₄·5H₂O (corresponds to 0.007% by weight of copper),

131 mg of MnSO₄·H₂O (corresponds to 0.013% by weight of manganese),

4.0 g of Zn(NO₃)₂·6H₂O (corresponds to 0.2% by weight of zinc),

3.0 g of FeSO₄·7H₂O (corresponds to 0.2% by weight of iron)

109 mg of molybdatophosphoric acid (12 MoO₃·H₃PO₄·x H₂O, water content 22% by weight, corresponds to 0.001% by weight of molybdenum)

60 g of phosphoric acid (B.3) are added. This gives formulation according to the invention EF.9. It is suitable for use for example as a citrus fruit fertilizer.

We claim:

1. The use of formulations comprising
(A) one or more aminocarboxylates, selected from among methylglycine diacetate (MGDA) and its alkali metal salts and glutamic diacetate (GLDA) and its alkali metal salts,
(B) at least one inorganic compound selected from among inorganic phosphates, inorganic phosphites, inorganic nitrates, ammonium salts and potassium salts and
(C) optionally water
for the application to plants, the ground or growth substrates.

2. The use according to claim 1, wherein inorganic compound (B) is selected from among sodium dihydrogenphosphate, disodium hydrogenphosphate, ammonium dihydrogenphosphate, diammonium hydrogenphosphate, potassium dihydrogenphosphate, dipotassium hydrogenphosphate, potassium nitrate, sodium nitrate, ammonium sulfate, superphosphate and alkali metal and alkaline-earth metal salts of tripolyphosphate, and natural phosphate-comprising minerals.

3. The use according to claim 1 or 2, which is the use as fertilizers.

4. The use according to any of claims 1 to 3, wherein the formulation comprises at least one organic compound (D), selected from among urea and citric acid and its alkali metal salts.

5. The use according to any of claims 1 to 4, wherein inorganic compound (B) is selected from among natural phosphate-comprising minerals.

6. The use according to any of claims 1 to 5, wherein the formulation comprises at least one cation selected from among Ca²⁺, Mg²⁺, Cu²⁺, Mn²⁺, Zn²⁺, Fe²⁺, Fe³⁺, Al³⁺, Cr³⁺ and Co²⁺ in chelated form.

7. A formulation comprising
(A) one or more aminocarboxylates, selected from among methylglycine diacetate (MGDA) and its alkali metal salts and glutamic diacetate (GLDA) and its alkali metal salts,
(B) at least one inorganic compound selected from among inorganic phosphates, inorganic phosphites, inorganic nitrates, ammonium salts and potassium salts and
(C) optionally water.

8. The formulation according to claim 7, which additionally comprises at least one polyaminocarboxylate (A).

9. The formulation according to claim 7 or 8, wherein inorganic compound (B) is selected from among sodium dihydrogenphosphate, disodium hydrogenphosphate, ammonium dihydrogenphosphate, diammonium hydrogenphosphate, potassium dihydrogenphosphate, dipotassium hydrogenphosphate, potassium nitrate, sodium nitrate, ammonium sulfate, superphosphate and alkali metal and alkaline-earth metal salts of tripolyphosphate, and natural phosphate-comprising minerals.

10. The formulation according to any of claims 7 to 9, which comprises at least one cation selected from among Ca²⁺, Mg²⁺, Cu²⁺, Mn²⁺, Zn²⁺, Fe²⁺, Fe³⁺, Al³⁺, Cr³⁺ and Co²⁺ in chelated form.

11. The formulation according to any of claims 7 to 10, which comprises at least one further substance selected from among
(D) organic compounds which are selected from among urea and citric acid and its alkali metal salts,
(E) active substances selected from among herbicides, fungicides and insecticides.

12. A process for the preparation of formulation according to any of claims 7 to 11, wherein
(A) one or more aminocarboxylate(s), selected from among methylglycine diacetate (MGDA) and its alkali metal salts and glutamic diacetate (GLDA) and its alkali metal salts, and
(B) at least one inorganic compound selected from among inorganic phosphates, inorganic phosphites, ammonium salts and potassium salts
are mixed with each other in the presence of water (C) and
all or some of the water (C) is optionally removed.

13. A process for the preparation of formulation according to any of claims 7 to 11, wherein a procedure is followed in which, in the presence of water (C) and
(A) one or more aminocarboxylate(s) (A), selected from among methylglycine diacetate (MGDA) and its alkali metal salts and glutamic diacetate (GLDA) and its alkali metal salts,
(B) at least one inorganic compound selected from among inorganic phosphates, inorganic phosphites, ammonium salts and potassium salts
is prepared and
all or some of the water (C) is optionally removed.

14. The process according to claim 12 or 13, wherein water (C) is removed by spray-drying or spraying-granulating.

15. A method of fertilizing plants, wherein at least one formulation according to any of claims 7 to 11 is applied mechanically or manually to the ground and/or to plants.

16. The use of aqueous formulations comprising
(A) one or more aminocarboxylates, selected from among methylglycine diacetate (MGDA) and its alkali metal salts and glutamic diacetate (GLDA) and its alkali metal salts,
for the application to plants or to the ground or to growth substrates.
